(19) United States
(12) Patent Application Publication
(10) Pub. No.: US 2014/0331816 A1
(43) Pub. Date: Nov. 13, 2014

(54) CAMSHAFT

(71) Applicant: Mahle International GmbH, Stuttgart (DE)

(72) Inventor: Walter Krepulat, Stuttgart (DE)

(73) Assignee: Mahle International GmbH, Stuttgart (DE)

(21) Appl. No.: 14/274,660

(22) Filed: May 9, 2014

(30) Foreign Application Priority Data
May 10, 2013 (DE) 102013208609.1

(51) Int. Cl. F01L 1/047; F16H 25/08

(52) U.S. Cl. CPC F01L 1/047; F16H 25/08; F01L 2001/0475
USPC 74/567

(57) ABSTRACT

A camshaft may include a camshaft tube and at least one functional component thermally joined thereon. The at least one functional component may have a through-opening for receiving the camshaft tube. Further, at least one of (i) the through-opening of the functional component may include a shaped contour and (ii) an outer contour of at least one of the camshaft tube and a bushing arranged between the camshaft tube and the functional component may include a shaped contour. The shaped contour is arranged in a region of the joining such that an asymmetrical deformation of the camshaft tube after thermal joining of the functional component is at least minimised.

### CROSS-REFERENCE TO RELATED APPLICATIONS

This application claims priority to German Patent Application No. 10 2013 208 609.1, filed May 10, 2013, the contents of which are hereby incorporated by reference in their entirety.

### TECHNICAL FIELD

The present invention relates to a camshaft, having a camshaft tube and at least one functional component joined thermally thereon, according to the preamble of claim 1. The invention also relates to a functional component for such a camshaft.

### BACKGROUND

During joining of non-round, asymmetrical functional components, in particular during thermal joining of cams (pump cams or valve actuation cams) to camshafts, deformation of the camshaft tube, that is, the camshaft, can occur in the region of the functional components owing to the transverse press fit and the associated contact between the cam bore and the camshaft tube diameter. Adjacent bearing faces can thereby also be deformed in such a manner that they are outside a tolerable specification and as a result must be post-machined, for example ground in a complex manner. Post-grinding is however an additional manufacturing step, as the camshaft has already been ground beforehand. This additional manufacturing step is not only complex and time-intensive, but of course also expensive. The non-uniform deformation of the camshaft is promoted by, among other things, the fact that the cam, or in general terms, the non-round functional component, varies in rigidity owing to its shape and thus the pressure on the camshaft is greater in the region of a cam peak than in the opposite base circle.

### SUMMARY

The present invention is therefore concerned with the problem of specifying an improved embodiment for a camshaft of the generic type, which in particular has a more cost- effective production method.

This problem is solved according to the invention by the subject matter of the independent claims. Advantageous embodiments form the subject matter of the dependent claims.

The present invention is based on the general concept of forming a camshaft having a camshaft tube and at least one functional component thermally joined thereon in the region of a join in such a manner that a variable contact is achieved and thereby at least minimising an asymmetrical deformation of the camshaft tube following the thermal joining of the functional component. This means that the contact in the join is variable depending on location and thus effects an advantageous deformation of the camshaft tube compared to a spatially constant contact, depending on the functional component to be joined. In a particularly advantageous embodiment, it is conceivable that the entire join forms a 3D free-form surface, which has been designed by a finite element simulation in such a manner that the deformation of the camshaft tube is minimised to the best possible extent.

Additionally or alternatively, a through-opening of the functional component can also be shaped in a similar manner, as a result of which the asymmetrical deformation of the camshaft tube and thus of the camshaft, which requires post-grinding at bearing points adjacent to the join, can likewise be at least minimised, preferably even eliminated. Corresponding formation of the through-opening of the functional component and/or of an outer contour of the camshaft tube or a bushing arranged thereon in the region of the join therefore allows the deformation of the camshaft tube after thermal joining to be greatly reduced, so that the bearing points preferably remain within a tolerable specification and do not have to be post-machined, in particular post-ground in a time- and cost-intensive manner.

In an advantageous development of the solution according to the invention, a bushing is arranged on the camshaft tube in the region of the join, which bushing forms the outer contour that interacts with the functional component. The machining of the outer contour of the camshaft described in the paragraph above and in the description below can relate to the direct outer contour of the camshaft tube or else to an outer contour of the bushing joined, for example pressed, onto the camshaft tube. The outer contour of the bushing then interacts with the through-opening of the functional component. The bushing can for example be formed from a lightweight metal, in particular aluminum, as a result of which increased friction can be achieved between the bushing and the camshaft tube, which is usually formed from steel. The bushing itself can be joined or pressed onto a non-machined camshaft tube, so that then only the bearing seat still needs to be ground. In particular, the outer face of the bushing can be machined particularly simply and cost-effectively thereby, in such a manner that an advantageous, location-dependent, variable contact with the functional component to be joined can be achieved. This can be implemented better on a component to be manufactured separately than for example on the camshaft tube directly.

In an advantageous development of the solution according to the invention, the outer contour of the camshaft (with or without the bushing) is elliptical and/or crowned in the region of the join. An elliptical or crowned formation of the outer contour effects a pressure or contact of the functional component on the camshaft or on the bushing that is variable depending on location, as a result of which a disadvantageously non-uniform exertion of force by the functional component on the camshaft during cooling of the functional component can be avoided and thus a disadvantageous deformation of the camshaft tube can be minimised.

The through-opening of the functional component is expediently drilled, turned or ground in a non-round manner. A non-round bore can for example be achieved by prestressing the functional component, for example the cam, during drilling, the non-round through-opening being produced on subsequent destressing or relieving of the functional component. This non-round through-opening has the effect, after thermal joining to the camshaft, that the latter does not or at least only minimally deforms, so that the camshaft retains its circular shape after thermal joining, which is of great significance in particular for bearing points arranged adjacently to the functional components. Complex and expensive post-machining of the camshaft, for example, grinding, which was previously sometimes necessary, is in particular no longer necessary thanks to the prevention of deformation of the camshaft tube and therefore of the camshaft after cooling of the functional components joined to it, so that the functional components, that is in the concrete case the cams, can be joined to the camshaft tube in a fully machined state.

To make the non-round through-opening in the functional component, the latter can for example be compressed elastically by means of a jaw-type clamping device, that is, elastically prestressed, and the actual cam bore can be made in this prestressed state. The cam bore made then has an initially circular shape, but becomes oval or elliptical as soon as the jaw-type clamping device is destressed and the functional component is elastically restored.

In a further advantageous embodiment of the camshaft according to the invention, the through-opening is drilled, ground, reamed, turned or milled. Just this non-exhaustive list demonstrates how multifarious the possibilities of producing a through-opening or the through-bore in the functional component, for example the cam, are. The through-opening is usually drilled and then post-machined by means of a cutting tool, for example a milling tool or a grinding tool. In the case of forged or sintered functional components, the bore is mostly already made by the manufacturing process and only has to be fine-machined.

The present invention is further based on the general concept of providing a non-round functional component, such as a cam, with a non-round through-opening, which at least minimises deformation of the camshaft after the thermal joining of the functional component. The through-opening is produced preferably by making a conventional bore with simultaneous elastic prestressing of the functional component. Owing to the subsequent destressing, the initially circular through-opening deforms in the manner of an oval, which results on thermal joining with the camshaft in radial forces, which act merely uniformly on the camshaft tube and effect no or at least no significant deformation of the camshaft, being present after the heated functional component has cooled or after the cooled camshaft tube has expanded, so that time-consuming grinding of adjacent bearing seats can be omitted. A long and a short diameter of the oval through-opening differ by approx. 5-25 μm when the functional component is destressed.

Further important features and advantages of the invention can be found in the subclaims, the drawings and the associated description of the figures using the drawings.

It is self-evident that the above-mentioned features and those still to be explained below can be used not only in the combination given in each case but also in other combinations or alone without departing from the scope of the present invention.

Preferred exemplary embodiments of the invention are shown in the drawings and are explained in more detail in the description below, the same reference symbols referring to the same or similar or functionally equivalent components.

### BRIEF DESCRIPTION OF THE DRAWINGS

In the figures,

FIG. 1 schematically shows a sectional diagram through a camshaft according to the invention in the region of a join with a functional component,

FIG. 2 schematically shows a diagram as in FIG. 1, but with a differently shaped camshaft and functional component,

FIG. 3 schematically shows a sectional diagram through a further embodiment of the camshaft according to the invention,

FIG. 4 schematically shows a diagram of a possible embodiment of a through-opening of the functional component and of an outer contour of the camshaft.

### DETAILED DESCRIPTION

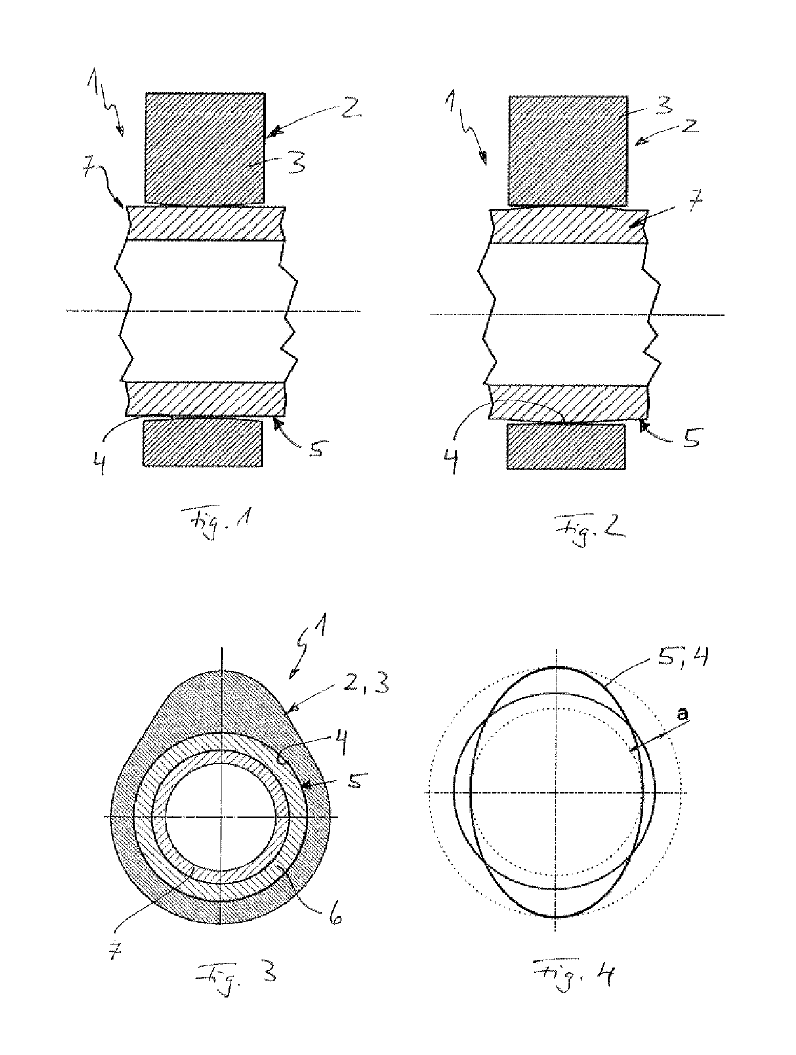

According to FIGS. 1 and 2, a camshaft 1 according to the invention has a camshaft tube 7 and at least one functional component 2, for example a cam 3, thermally joined thereon. According to the invention, a through-opening 4 of the functional component 2 and/or an outer contour 5 of the camshaft tube 7 or of a bushing 6 arranged thereon are shaped in the region of the join in such a manner that an asymmetrical deformation of the camshaft tube 7 and therefore of the camshaft 1 after thermal joining of the functional component 2 to the camshaft tube 7 is at least minimised, preferably even eliminated.

The outer contour 5 of the camshaft tube 7 can in this case be elliptical in particular in the region of the join, as is shown for example in FIG. 4. A crowned outer contour 5 of the camshaft tube 7 is likewise possible, as is shown in FIG. 2. In the same manner, the through-opening 4 of the functional component 2, in particular of the cam 3, can of course also be crowned, as can be seen for example in FIG. 1, it also being possible for a non-round through-opening 4, in particular an elliptical through-opening 4, of the functional component 2 to be provided. A difference a between a long diameter and a short diameter can be 5-25 μm (cf. FIG. 4), it being possible to provide the difference a in the region of the through-opening 4 on the functional component 2 and/or in the region of the outer contour 5 of the camshaft tube 7.

The outer contour 5 can be formed directly on the camshaft tube 7 or else in the region of the bushing 6 (cf. FIG. 3) that is pressed onto the camshaft tube 7 in the region of the join. A bushing 6 of this type can for example be formed from lightweight metal, in particular from aluminum, as a result of which increased friction can be achieved between the camshaft tube 7, which is usually formed from steel, and the bushing 6. The functional component 2 can generally be configured as a cam 3 or else as a sensor wheel. The outer contour 5 of the camshaft tube 7 or of the bushing 6 can be produced by turning or grinding.

The non-round through-opening 4 of the functional component 2 can for example be produced by elastically prestressing the functional component 2 and subsequently making a bore. The initially circular bore deforms in an oval or elliptical manner after destressing of the functional component 2, the non-round through-opening 4 having the effect that, during subsequent thermal joining of the functional component 2 to the camshaft tube 7, preferably only uniform radial forces act on the camshaft tube 7, so that the latter is not deformed or is only deformed marginally, so that in particular bearing points arranged adjacently to the functional component 2 do not have to be post-machined, in particular post-ground.

If a bushing 6 is used, as shown in FIG. 3, this can be machined subsequently on the outside in relation to the outer contour 5, which is much simpler in manufacturing terms. The configuration according to the invention of the through-opening 4 of the functional component 2 and/or of the outer contour 5 of the camshaft tube 7 or of the bushing 6 in the region of the respective join means that an asymmetrical deformation of the camshaft tube 7 and thus of the camshaft 1 after thermal joining of the functional component 2 on the camshaft 1 can be at least minimised, preferably even eliminated, as a result of which the previously necessary post-grinding of bearing points or bearing seats arranged adjacently to the functional component 2 can be avoided.

1. A camshaft, comprising: a camshaft tube and at least one functional component thermally joined thereon, the at least one functional component having a through-opening for receiving the camshaft tube, wherein at least one of (i) the through-opening of the functional component includes a shaped contour and (ii) an outer contour of at least one of the camshaft tube and a bushing arranged between the camshaft tube and the functional component includes a shaped contour, and wherein the shaped contour is arranged in a region of the join such that an asymmetrical deformation of the camshaft tube after thermal joining of the functional component is at least minimised.

2. The camshaft according to claim 1, wherein the bushing is arranged on the camshaft tube in the region of the joining, the bushing forming the outer contour that interacts with the through-opening of the functional component.

3. The camshaft according to claim 1, wherein the outer contour of at least one of the camshaft tube and the bushing is at least one of elliptical and crowned in the region of the joining

4. The camshaft according to claim 1, wherein the through-opening of the at least one functional component is crowned.

5. The camshaft according to claim 1, wherein the through-opening of the functional component is non-round.

6. The camshaft according to claim 2, wherein the bushing is formed from lightweight metal.

7. The camshaft according to claim 2, wherein the outer contour of at least one of the camshaft tube and the bushing is at least one of turned and ground.

8. The camshaft according to claim 1, wherein the through-opening of the functional component is at least one of drilled, turned and ground in a non-round manner.

9. The camshaft according to claim 1, wherein the functional component is at least one of a sensor wheel and a cam.

10. The camshaft according to claim 1, wherein the through-opening of the functional component is oval when the functional component is destressed, wherein a difference between a long diameter and a short diameter of the through-opening is approximately 5 to 25 μm.

11. A functional component for a camshaft, comprising:
a through-opening for receiving a camshaft tube, the through-opening having at least one of a non-round contour and crowned contour;
wherein the through-opening includes a long diameter and a short diameter, the long and short diameter differing by approximately 5 to 25 μm.

12. The functional component according to claim 11, wherein the through-opening is at least one of oval and elliptical.

13. The camshaft according to claim 2, wherein the outer contour of the bushing is at least one of elliptical and crowned.

14. The camshaft according to claim 13, wherein the through-opening of the functional component is at least one of non-round and crowned.

15. The camshaft according to claim 2, wherein the through-opening of the functional component is at least one of non-round and crowned.

16. The camshaft according to claim 3, wherein the through-opening of the functional component is at least one of non-round and crowned.

17. A camshaft for an internal combustion engine, comprising:
a camshaft tube having at least one functional component mounted thereon, the at least one functional component having a through-opening for receiving the camshaft tube; and
an outer contour extending around the camshaft tube in a region of the functional component mounting, the outer contour interacting with the through-opening;
wherein at least one of (i) the through-opening of the functional component and (ii) the outer contour surrounding the camshaft tube includes a shaped contour that is at least one of elliptical and crowned, the shaped contour including a long diameter and a short diameter, the long and short diameter differing approximately 5 to 25 μm;
wherein the shaped counter of at least one of the through-opening and the outer contour effects variable contact of the functional component relative to the camshaft tube.

18. The camshaft according to claim 17, further comprising a bushing arranged between the at least one functional component and the camshaft tube, the bushing forming the outer contour surrounding the camshaft tube interacting with the functional component.

19. The camshaft according to claim 18, wherein the outer contour of the bushing is at least one of elliptical and crowned.

20. The camshaft according to claim 17, wherein the outer contour is formed directly on the camshaft tube.
